(19) United States
(12) Patent Application Publication
(10) Pub. No.: US 2014/0006278 A1
(43) Pub. Date: Jan. 2, 2014

(54) SAVE TO OPEN WALLET

(71) Applicant: EBAY INC., San Jose, CA (US)

(72) Inventors: Nikhil S. Sathe, Monte Sereno, CA (US); Norihiro Edwin Aoki, San Jose, CA (US)

(21) Appl. No.: 13/872,835

(22) Filed: Apr. 29, 2013

Related U.S. Application Data
(60) Provisional application No. 61/665,685, filed on Jun. 28, 2012.

(51) Int. Cl. G06Q 20/36

(52) U.S. Cl. CPC G06Q 20/36
USPC 705/41

(57) ABSTRACT

The present disclosure involves a system. The system includes a computer memory storage module configured to store executable computer programming code. The system includes a computer processor module operatively coupled to the computer memory storage module. The computer processor module is configured to execute the computer programming code to perform the following operations: receiving, from a service provider, a request to set up a digital wallet triggering element; generating a unique key in response to the request; sending the key to the service provider to facilitate a setup of the digital wallet triggering element by the service provider; and storing, in response to an activation of the digital wallet triggering element, an item to a digital wallet of a user.

### CLAIM OF PRIORITY

The present application claims priority to U.S. Provisional Patent Application No. 61/665,685, filed on Jun. 28, 2012 and titled “SAVE TO OPEN WALLET”, the content of which is herein incorporated by reference in its entirety.

### BACKGROUND

1. Technical Field

The present disclosure generally relates to payments, and more particularly, to an enhanced digital wallet.

2. Related Art

The recent rapid advances in computer technology and telecommunications have increased the popularity of online transactions. Online transactions are becoming more and more prevalent, with an ever-increasing number of online entities that may or may not have a physical real world counterpart. Furthermore, the services offered by these online entities have been improving as well. The popularity of online transactions is partially attributable to the ease and convenience of making a transaction online instead of at a physical location. For example, a consumer can use a digital wallet to conduct purchasing transactions online. However, conventional digital wallets may lack some of the functionalities of their real world counterparts. Thus, what is needed is an enhanced digital wallet that is more versatile at storing user-specified content so as to better simulate a real wallet.

### BRIEF DESCRIPTION OF THE DRAWINGS

FIG. 1 is a simplified block diagram illustrating an infrastructure enabling a digital wallet according to various aspects of the present disclosure.

FIGS. 2-4 are example flowcharts illustrating various processes that take place to enable the digital wallet according to various aspects of the present disclosure.

FIGS. 5-7 are simplified example user interfaces of a digital wallet according to various aspects of the present disclosure

FIG. 8 is an example flowchart of conducting a transaction using a digital wallet according to various aspects of the present disclosure.

FIG. 9 is an example computer system for implementing the various steps of the method of FIG. 8 according to various aspects of the present disclosure

FIG. 10 is a simplified example of a cloud-based computing architecture according to various aspects of the present disclosure.

FIG. 11 is a simplified block diagram of an electronic system for implementing various methods and devices described according to various aspects of the present disclosure.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity.

As mobile computing and communication technologies continue to advance, online transactions are becoming increasingly more prevalent. The popularity of making online transactions is partially attributed to the ease and convenience of these transactions. A digital wallet can be used to perform these transactions. However, conventional digital wallets typically only contain funding instruments such as credit or debit cards. In comparison, wallets in the real world may contain a variety of other items such as receipts, train or bus passes, coupons, tickets, loyalty cards, and even a photograph or two. Whether it's because these items are related to a transaction, or because the wallet forms a convenient, easily accessible storage place, these items should be as easy to store and access in a digital wallet as they are in their physical counterpart.

According to the present disclosure, an enhanced digital wallet is described, which is more versatile in its ability to store, and allowing its user to manage, a variety of items. For ease of reference, the enhanced digital wallet of the present disclosure may also be referred to as an “Open Wallet” hereinafter.

The “Open Wallet” is so named because it provides an open platform through which users can store information into a digital wallet set up by a payment provider. For example, service providers that wish to enable items to be added into the digital wallet of a customer need include only a small amount of website code on their web pages in order to present an “Add to Wallet” button. When a consumer clicks the button, this website code executes, resulting in the addition of the item into the digital wallet of the customer. The creation of a platform to enable the “Open Wallet” concept and the interaction of the participants by which to bring it about are discussed in more detail below. It is understood, however, that the digital wallet can also be set up by entities other than a payment provider in various other embodiments.

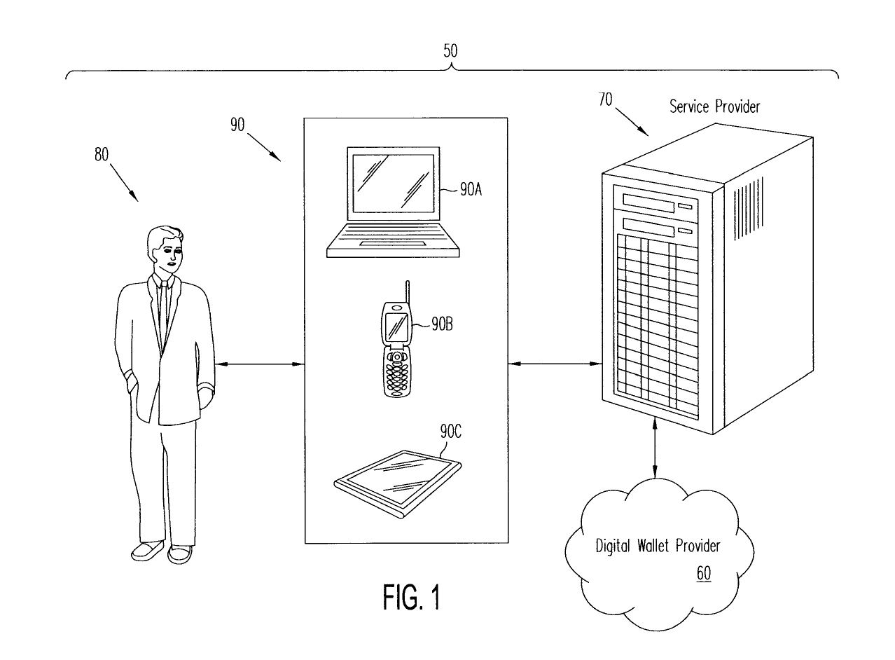

FIG. 1 is a simplified high-level block diagram view of an infrastructure (or system) 50 that enables the “Open Wallet” concept. The infrastructure 50 includes a digital wallet provider 60, a service provider 70, and a user 80. In various embodiments, the digital wallet provider 60 may be a financial institution or a third party payment provider, for example PayPal®, Inc. of San Jose, Calif., or a similar entity. The service provider 70 may be a merchant offering physical and tangible goods, including (but not limited to) clothing, electronics, tools, toys, household appliances, books, movies, automotive components, sporting goods, groceries, etc. The service provider 70 may also be a merchant offering digital goods or services, including electronic-books, digital music, digital images, digital videos, virtual items, or other subscription-based services, etc. The user 80 has an account with the digital wallet provider 60. In some embodiments, the user 80 may also be a customer of the service provider 70 and may have an account with the service provider 70. However, it is understood that the user 80 need not necessarily have a pre-existing relationship with the service provider 70.

As is shown in FIG. 1, the service provider 70 is configured to conduct electronic communications with external entities, for example the digital wallet provider 60. The user 80 may also electronically communicate with external entities, for example the service provider 70, through one or more electronic communications devices 90. As examples, the electronic communications devices 90 may include a computer 90A, a mobile telephone 90B, or a computer tablet 90C. These electronic communications devices 90 may communicate with one or more computers of the service provider 70 under a suitable wired or wireless telecommunications protocol. It is understood that, although FIG. 1 shows arrows between the service provider 70 and the digital wallet provider 60, a pre-existing relationship between them is not needed. According to the features of the Open Wallet disclosed herein, no specific service-to-service interaction is required between service provider 70 and wallet provider 60. Similar to a Facebook® “Like” button, the communication is mediated through one of the user's devices 90. In the cases where it's a storage only relationship, it's possible for the Open Wallet to work even when the service provider 70 and the digital wallet provider 60 have no preexisting relationship (other than the service provider's registration of a key and the inclusion of some code/content supplied by the digital wallet provider 60, as discussed below in more detail).

As a part of the electronic communication, the service provider 70 may display a website to the user 80. The website may contain a triggering element that can be activated by a corresponding action from the user 80, so that items can be added to a digital wallet of the user 80. For example, the website may contain an “Add to Wallet” button that may be triggered when the user 80 clicks on it. When a web browser (not shown) has detected a user click of this button, it directs the request to the digital wallet provider 60 to add some information to the digital wallet for the user 80. The request always includes metadata that identifies the content and whether there are any actions that can be associated with it. For example, the content might be identified as a receipt corresponding to a particular transaction at a particular merchant's website. As another example, the content may be a coupon that can be redeemed a certain number of times. There is no requirement for the digital wallet provider 60 to retrieve any content from the service provider 70, though the service provider 70 can specify instructions in the metadata that allow the user's web browser to retrieve additional content, such as a picture or logo, from the service provider 70, when the stored item is displayed to the user 80.

In some embodiments, for the service provider 70 to set up the trigger (e.g., the “Add to Wallet” button) on its website, the service provider 70 has to go through a configuration process with the digital wallet provider 60. This configuration process can be achieved through any means by which the service provider 70 and digital wallet provider 60 can communicate. For example, the configuration process may be done through the use of an online form. As part of the configuration process, the service provider 70 identifies itself to the digital wallet provider 60. The digital wallet provider 60 then gives the service provider a unique key or token that identifies a given trigger to the system.

The service provider 70 may set up multiple triggers corresponding to different bits of information to be stored in the digital wallet. In some embodiments, each trigger may contain, among other things, a name that identifies the information to be stored in the wallet; a type (e.g., coupon, receipt, ticket, etc.) that describes the kind of information it is; an action URL, which gives a location to which to direct the user when he or she wishes to take action on the information; and an image URL, which specifies an online location from which the digital wallet provider can retrieve a graphical representation of the information represented by the content.

The service provider 70 may also provide some amount of additional data in conjunction with the content, such as a unique token, expiration date, or the service provider's own user information that can be used to assist in carrying out the specified action. It is understood that the configuration process discussed above may be performed at a set up time (before the user activates the trigger), or it may be performed dynamically by the service provider 70 in response to the user 80's activation of the trigger (i.e., clicking on the button).

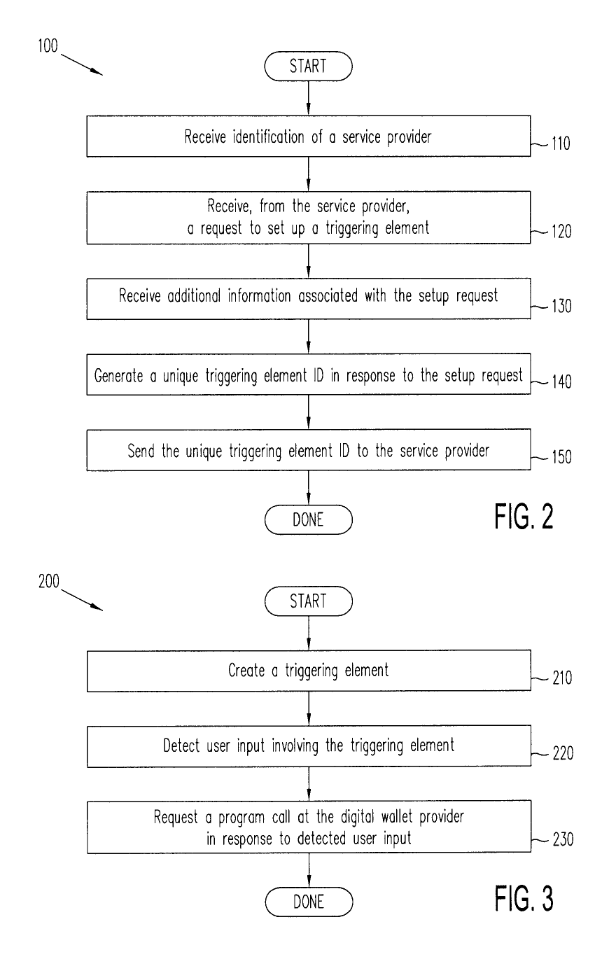

FIG. 2 is a flowchart of a simplified method 100 that illustrates an example setup or configuration process between the service provider 70 and the digital wallet provider 60 according to various aspects of the present disclosure. In the context of this example, the service provider 70 may be otherwise unaffiliated with the digital wallet provider 60. For instance, the digital wallet provider 60 may be a payment provider such as PayPal that offers online transactional tools such as its checkout or cart products. The service provider 70 may be an online merchant that does not necessarily use these transactional tools of PayPal's. Nevertheless, the service provider 70 may wish to create a button (i.e., a form of a triggering element) that allows a user (such as the user 80) to keep a copy of a receipt corresponding to a given transaction in her digital wallet. Further, the service provider 70 may wish that when the user clicks on the receipt, she is taken back to the service provider 70's merchant website where she can review her past order history. The service provider 70 therefore goes through the setup process corresponding to the method 100 with the digital wallet provider 60.

The method 100 includes a step 110, in which the digital wallet provider 60 receives identification of the service provider 70. The identification process may include an authentication process, where the service provider 70 has to authenticate itself to the digital wallet provider 60 to prove that it is who it says it is.

The method 100 includes a step 120, in which the digital wallet provider 60 receives a request from the service provider 70 to set up a triggering element. In some embodiments, the triggering element may be an “Add to Wallet” button with a content type of “receipt.”

The method 100 includes a step 130, in which the digital wallet provider 60 receives additional information associated with the setup request of the step 120. For instance, the service provider 70 may provide an action URL (Uniform Resource Locator, which constitutes a reference to an Internet resource) and/or an image URL to accompany the setup request. As an example, the action URL may be “http://vvww.example.com/cgi-bin/order-history”, and the image URL may be “http://www.example.com/cgi-bin/receipt-image.” The service provider 70 need not provide a name since the contents of the receipt may be generated dynamically. In an embodiment, the service provider 70 may also specify that additional pieces of metadata—such as “userID” and “orderID”—will be supplied as part of both the image and action callbacks.

The method 100 includes a step 140, in which the digital wallet provider 60 generates a unique triggering element identifier (ID) in response to the setup request from the service provider 70. For example, the digital wallet provider 60 may generate a unique button ID as the triggering element ID. Thereafter, in a step 150, the digital wallet provider 60 sends the unique triggering element ID to the service provider 70. It is understood that although the method 100 conflates the service provider's original setup process and the setup of the triggering element, these setup processes need not be performed in conjunction with one another. The setup of the triggering element can happen dynamically, but the identification of the merchant (e.g., step 110) would be done once, when the original key ID was generated. In most cases, the identification of the merchant as part of the triggering element configuration (e.g., when a button is clicked by the user) happens by passing in a previously generated key as metadata, as in step 120, and not as a separate authentication step from the service provider in step 110.

Continuing with the example context discussed in FIG. 2, FIG. 3 is a flowchart of a simplified method 200 that illustrates actions performed by the service provider 70 and a user agent (e.g., a web browser) once the unique triggering element ID has been received from the digital wallet provider 60. The method 200 includes a step 210, in which the service provider 70 uses the unique triggering element ID to “create” the triggering element by specifying the metadata it wants (including the ID) and displaying it to the user 80. This activation can take the form of an HTTP form post, Javascript action, or any other mechanism by which a client request is sent to the server. For the purpose of this example, an HTTP form post is used, as it provides an easy to read example:

<form method=“POST”
action=“https://www.paypal.com/cgi-bin/addtowallet/”>
<input type=“hidden” name=“userID” value=“12345”
<input type=“hidden” name=“orderID” value=“6789”
<input type=“hidden” name=“PP_WALLET_CONTENT_NAME”
value=“Receipt for order 6789 on Jan 1, 2011”>
<input type=“hidden” name=“PP_WALLET_KEY”
value=“1G26a42f62De91”>
<input type=“image” name=“Add”
url=“https://www.paypal.com/images/add_button.jpg”>
</form>

This bit of HTML code will display to the user (such as the user 80 of FIG. 1) a button (i.e., the triggering element in this example) on a website of the service provider 70. The button is specified by the image given in the URL “https://www.paypal.com/images/add_button.jpg”. The PP_WALLET_KEY is a unique ID given to the service provider 70 by the digital wallet provider 60. The PP_WALLET_KEY corresponds to a given item to store in a user's digital wallet. It is understood that the service provider may also insert the above HTML code into the order confirmation page or into an order confirmation email sent to the user, thereby allowing the user/purchaser to add the receipt for the transaction into her digital wallet.

The method 200 includes a step 220, in which the web browser (a form of User Agent) detects a user input involving the triggering element (i.e., the button). In some embodiments, the user input may be a press or a click of the button. The web browser (or any other user agent) reads the metadata as configured and sends it to the digital wallet provider 60.

The method 200 includes a step 230, in which a program call at the digital wallet provider 60 is requested in response to the detected user input in the step 220. In some embodiments, upon a detected user press or click of the button, a program call will be requested at “https://www.paypal.com/cgi-bin/addtowallet” with four parameters, which are named userID, orderID, PP_WALLET_CONTENT_NAME, and PP_WALLET_KEY.

Again, continuing with the example context discussed in FIGS. 2-3, FIG. 4 is a flowchart of a simplified method 300 that illustrates the actions performed by the digital wallet provider 60 once it receives the program call request from the service provider 70.

The method 300 includes a step 310, in which the user (who pressed the button) is identified and authenticated by the digital wallet provider 60. In some embodiments, the user may be prompted to enter security credentials such as a username, a password, and/or a Personal Identification Number (PIN) to identify and authenticate herself to the digital wallet provider 60. Of course, if the user had already been authenticated previously, this step may be omitted.

The method 300 includes a step 320, in which the digital wallet provider 60 retrieves the information supplied by the service provider 70. Note that the service provider 70 does not actually “store” any information with the digital wallet provider 60. The information supplied by the service provider 70 includes part of the metadata used to configure the triggering element discussed above. In many cases, the digital wallet provider 60 will not have had any previous knowledge of the information supplied by the service provider 70. The step 320 may be done after the value provided from the PP_WALLET_KEY is validated. For example, the digital wallet provider 60 may retrieve the action and image URLs previously stored by the service provider 70.

The method 300 includes a step 340, in which the digital wallet provider 60 retrieves the content specified by the service provider's program call request. For example, the specified content herein may be the image specified at the image URL's callback. This retrieval process may be performed when the digital wallet provider 60 is satisfied that all of the necessary information has been supplied. In embodiments where the service provider 70 has specified additional parameters, the digital wallet provider 60 appends these to the URL it retrieves, e.g., “http://www.example.com/cgi-bin/receipt-image?userID=12345&orderID=6789”. This retrieved image, which may be static or may be dynamically generated, is now stored in the user's digital wallet of the digital wallet provider 60. It is understood that the digital wallet provider 60 may not retrieve the content such as the image from the service provider 70. It will instead send the URL (perhaps with additional appended content) to the user's web browser, and the browser may retrieve said content.

Of course, the digital wallet provider 60 may perform additional steps before, during, or after the steps 310-340 discussed herein. For example, in some embodiments, the digital wallet provider 60 may perform additional checks as necessary to prevent fraud and other malicious behavior, such as verifying an action's referrer is consistent with a URL provided by the service provider 70 at setup. As another example, the digital wallet provider 60 may perform additional operations on the image (i.e., the retrieved content) prior to storing it on behalf of the user, such as analyzing it for obscene or copyrighted material or generating a thumbnail to help the user to identify the content. Note that one or more of the steps described herein may be omitted, combined, or performed in a different sequence as desired.

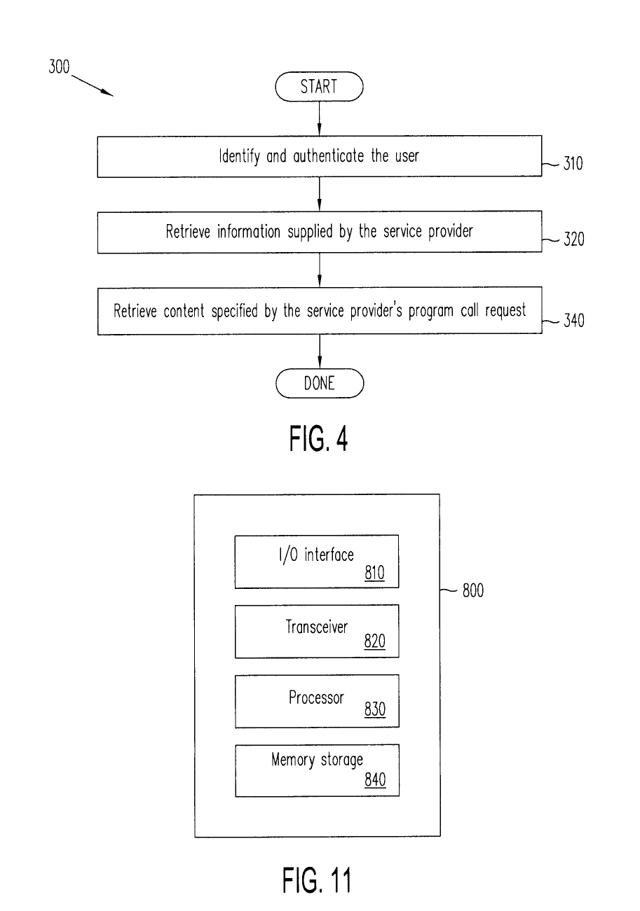

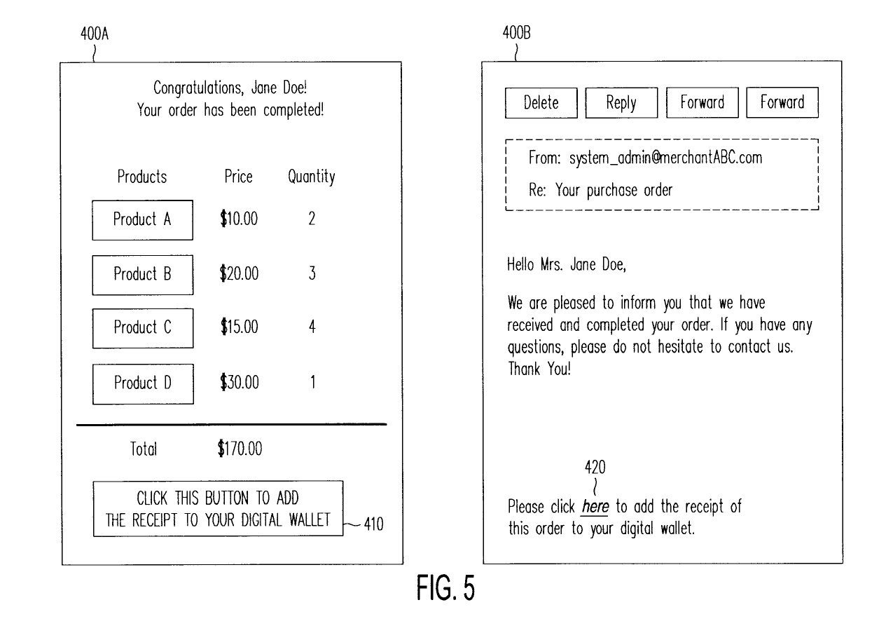

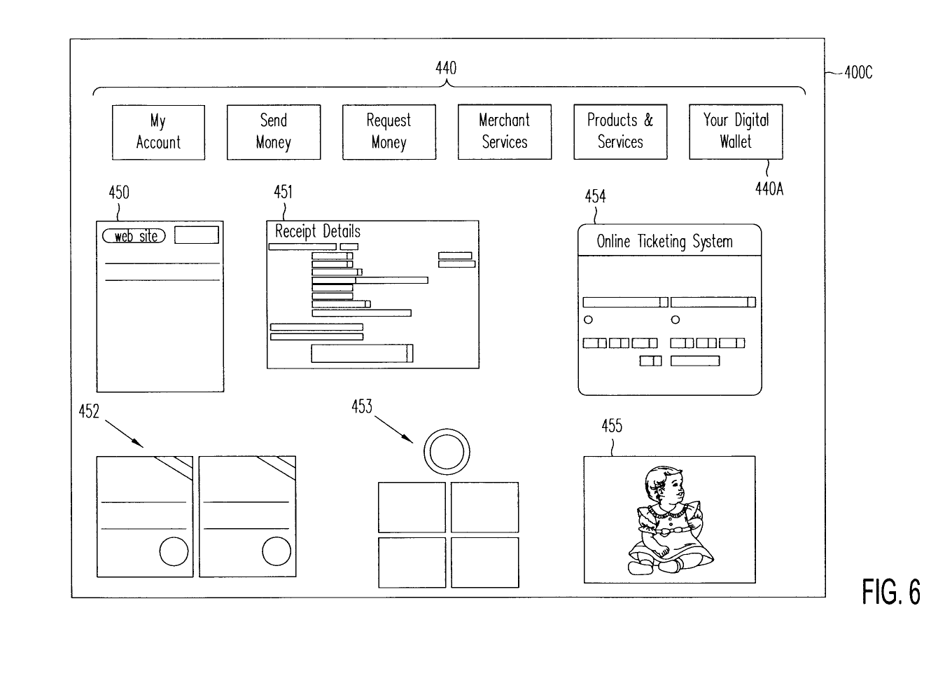

FIGS. 5-6 illustrate some example user interfaces through which a user (such as the user 80 of FIG. 1) may manage her digital wallet according to various aspects of the present disclosure. Referring to FIG. 5, a user interface 400A displays an example checkout screen shown by a merchant website to its user Jane Doe. The checkout screen may display a message telling the user that her order has been completed, as well as a short summary of the products included in the purchase. The checkout screen may also display a virtual button 410 as a triggering element. The virtual button 410 is set up as a triggering element by the merchant (i.e., an example service provider) in accordance with the configuration process discussed above with reference to FIG. 2. The virtual button 410 may include a message “click this button to add the receipt to your wallet.” The user's click of the button 410 may trigger the processes discussed above in FIGS. 3-4 and enables the user to add the receipt to her digital wallet with a digital wallet provider, for example PayPal. Thereafter, the user may view (or otherwise manage) the receipt of this transaction by logging on to her digital wallet account with the digital wallet provider.

FIG. 5 also shows another user interface 400B that displays an example message (e.g., an email message) sent from the merchant to the user Jane Doe. The message may inform the user that her order has been received and completed. The message may also display a link (or a virtual button, or any other suitable virtual mechanism) as a triggering element. For example, the message may state “Please click here to add the receipt of this order to your digital wallet”, where “here” is a link 420. Similar to the button 410, the user's click of the link 420 may also trigger the processes discussed above in FIGS. 3-4 and enables the user to add the receipt to her digital wallet with a digital wallet provider.

Referring now to FIG. 6, an example user interface 400C is shown that illustrates the various types of items included in a sample digital wallet. To gain access to the items in her digital wallet, a user logs on to her account with the digital wallet provider. After supplying the authentication information (e.g., user name and password), the user logs on to her account and may be presented with a plurality of tabs 440. For example, the tabs may include: “My Account”, “Send Money”, “Request Money”, “Merchant Services”, “Products & Services”, and a “Your Digital Wallet” tab 440A. When the user clicks on the “Your Digital Wallet” tab 440A, the items previously stored in her digital wallet may appear on the screen. As non-limiting examples, these items may include receipts 450-451, coupons 452-453, a ticket 454, and a photograph 455. Other examples of items that may be stored in her digital wallet may include transportation passes, credit cards, loyalty cards, etc.

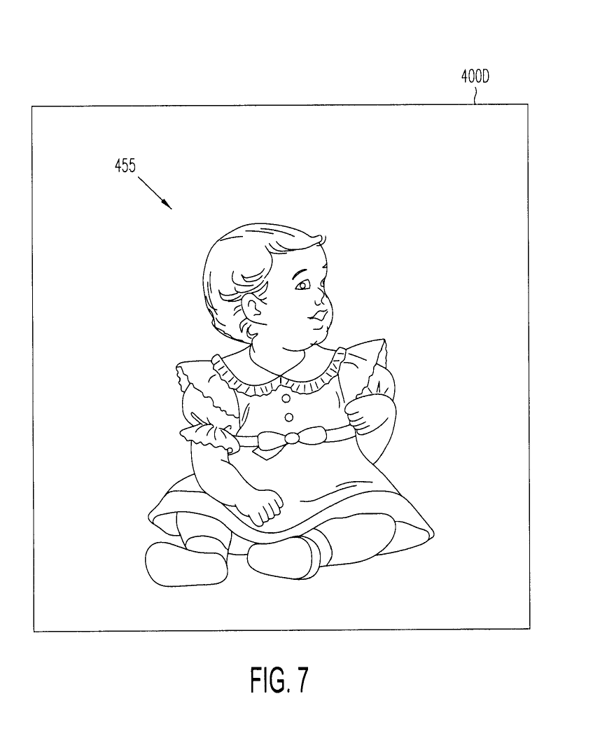

In the embodiment shown in FIG. 6, the items 450-455 are shown as thumbnail images. The user may click on any one of the items 450-455 for a larger, more detailed view of the item. For example, FIG. 7 shows an example user interface 400D that displays a more detailed, “full version” of the item 455. In other words, the item 455 is now displayed to the user in a full sized (or larger) view, instead of the smaller, condensed “thumbnail” view in the user interface 400C of FIG. 6. Similarly, the receipts 450-451 may be opened as full-size PDF files (not shown herein for the sake of simplicity).

The user may also move these items 450-455 around on the screen, resize them, rotate them, delete them, or perform other suitable manipulations to them. In some embodiments, at least some of the items 450-455 may also have an accompanying link, for example a “More Information” link. The user may click on such links if she indicates she wants to take further action. For example, upon the click of the “More Information” link, the user may be directed to a previously specified action URL, again with the additional parameters specified, e.g., “http://www.example.com/cgi-bin/order-history?userID=12345&orderID=6789” where she can interact with the merchant to ask questions about her order.

The combination of a platform for the storage of discrete bits of digital information into a digital storage (wallet) on behalf of a given user by a service provider and that allows for a feedback loop back to the service provider is advantageous. It is understood, however, that not all advantages are discussed herein, other embodiments may offer different advantages, and no advantage required for all embodiments. In one regard, the open wallet discussed herein is valuable for service providers because it allows for the storage of bits of data in an end user's wallet with minimal infrastructure investment. Although certain examples above involve dynamically generated content (e.g, the receipt image), the idea will work equally well with a static image (for example, an image of a coupon, loyalty card, etc.). The addition of an “action” URL then allows the user to interact further with the stored content and/or the service provider, and the allowance for additional metadata to be specified by the service provider allows for the service provider to make use of additional information that can be provided to validate the operation. Other actions that might be relevant could include checking in for an airline itinerary, redeeming a coupon, tracking a package, paying back a promissory note, specify an expiration date for a coupon or ticket, or any other action that can be initiated via a URL, etc.

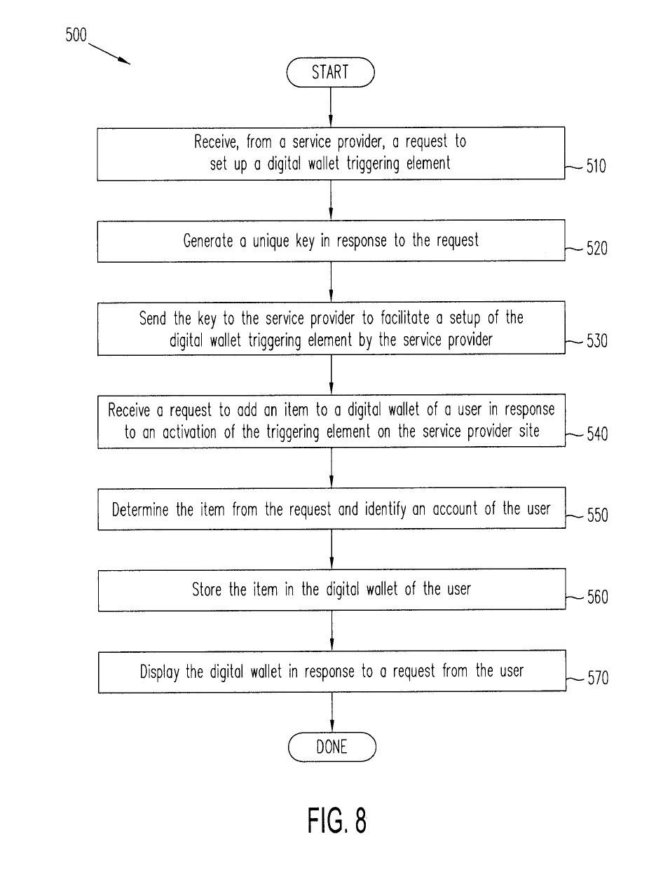

FIG. 8 is a flowchart illustrating a method 500 for managing a digital wallet. The method 500 includes a step 510, in which a request to set up a digital wallet triggering element is received from a service provider. In some embodiments, the digital wallet triggering element comprises a virtual button on a webpage of the service provider.

The method 500 includes a step 520, in which a unique key is generated in response to the request in step 510. The method 500 includes a step 530, in which the key is sent to the service provider to facilitate a setup of the digital wallet triggering element by the service provider.

The method 500 includes a step 540, in which a request is received to add an item to a digital wallet of a user in response to an activation of the triggering element. The method 500 includes a step 550, in which the item is determined based on the request, and an account of the user is identified. The method 500 includes a step 560, in which the item is stored to a digital wallet of a user.

The method 500 includes a step 570, in which the digital wallet is displayed in response to a request from the user. The digital wallet may include one or more receipts, transportation passes, coupons, tickets, loyalty cards, and photographs as items contained therein. In some embodiments, the digital wallet is displayed as a collection of thumbnail versions of the items in the digital wallet. In some embodiments, the step 570 includes displaying a full version of a selected one of the items in the digital wallet upon user request. The full version contains more details of the item than its thumbnail version.

In some embodiments, the steps 510-570 are performed by a digital wallet provider. The service provider may be unaffiliated with the digital wallet provider. The service provider may be a merchant, and the user may be a customer of the merchant. It is understood that additional method steps may be performed before, during, or after the steps 510-570 discussed above. For example, in some embodiments, the method 500 may include a step of authenticating the user before the item is stored to the digital wallet of the user. As another example, the method 500 may include a step of analyzing the item to detect fraud or obscene or copyrighted material before the item is stored to the digital wallet of the user.

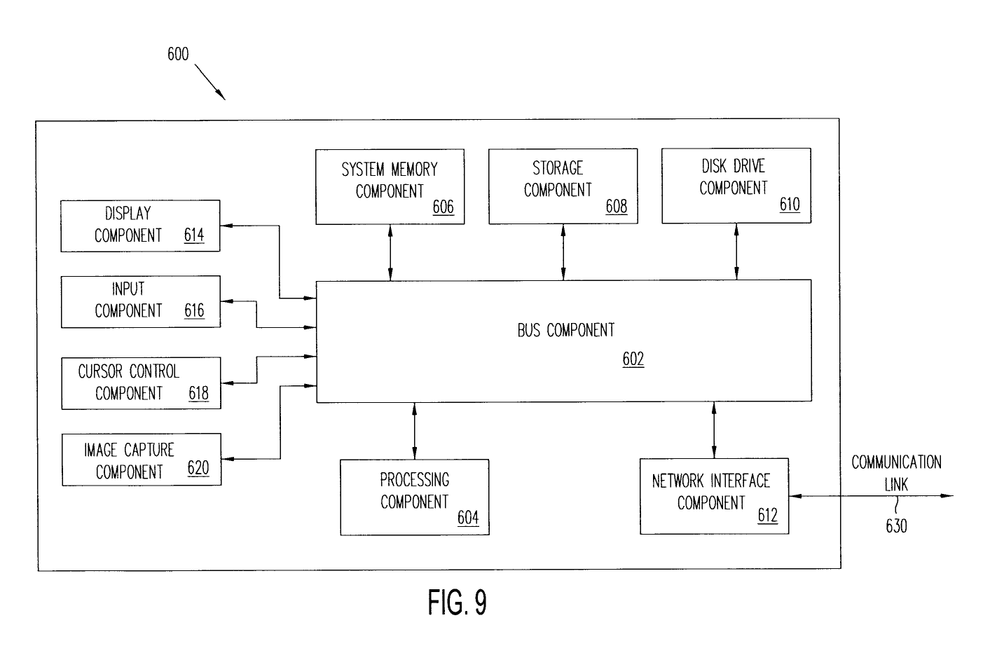

FIG. 9 is a block diagram of a computer system 600 suitable for implementing various methods and devices described herein, for example, the various method steps of the methods 100, 200, 300, and 500. In various implementations, the devices capable of performing the steps may comprise a network communications device (e.g., mobile cellular phone, laptop, personal computer, tablet, etc.), a network computing device (e.g., a network server, a computer processor, an electronic communications interface, etc), or another suitable device. Accordingly, it should be appreciated that the devices capable of implementing the method 100, 200, 300, and 500 may be implemented as the computer system 600 in a manner as follows.

In accordance with various embodiments of the present disclosure, the computer system 600, such as a network server or a mobile communications device, includes a bus component 602 or other communication mechanisms for communicating information, which interconnects subsystems and components, such as a computer processing component 604 (e.g., processor, micro-controller, digital signal processor (DSP), etc.), system memory component 606 (e.g., RAM), static storage component 608 (e.g., ROM), disk drive component 610 (e.g., magnetic or optical), network interface component 612 (e.g., modem or Ethernet card), display component 614 (e.g., cathode ray tube (CRT) or liquid crystal display (LCD)), input component 616 (e.g., keyboard), cursor control component 618 (e.g., mouse or trackball), and image capture component 620 (e.g., analog or digital camera). In one implementation, disk drive component 610 may comprise a database having one or more disk drive components.

In accordance with embodiments of the present disclosure, computer system 600 performs specific operations by the processor 604 executing one or more sequences of one or more instructions contained in system memory component 606. Such instructions may be read into system memory component 606 from another computer readable medium, such as static storage component 608 or disk drive component 610. In other embodiments, hard-wired circuitry may be used in place of (or in combination with) software instructions to implement the present disclosure.

Logic may be encoded in a computer readable medium, which may refer to any medium that participates in providing instructions to the processor 604 for execution. Such a medium may take many forms, including but not limited to, non-volatile media and volatile media. In one embodiment, the computer readable medium is non-transitory. In various implementations, non-volatile media includes optical or magnetic disks, such as disk drive component 610, and volatile media includes dynamic memory, such as system memory component 606. In one aspect, data and information related to execution instructions may be transmitted to computer system 600 via a transmission media, such as in the form of acoustic or light waves, including those generated during radio wave and infrared data communications. In various implementations, transmission media may include coaxial cables, copper wire, and fiber optics, including wires that comprise bus 602.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 630 (e.g., a communications network, such as a LAN, WLAN, PTSN, and/or various other wired or wireless networks, including telecommunications, mobile, and cellular phone networks) may perform instruction sequences to practice the present disclosure in coordination with one another.

Computer system 600 may transmit and receive messages, data, information and instructions, including one or more programs (i.e., application code) through communication link 630 and communication interface 612. Received program code may be executed by computer processor 604 as received and/or stored in disk drive component 610 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

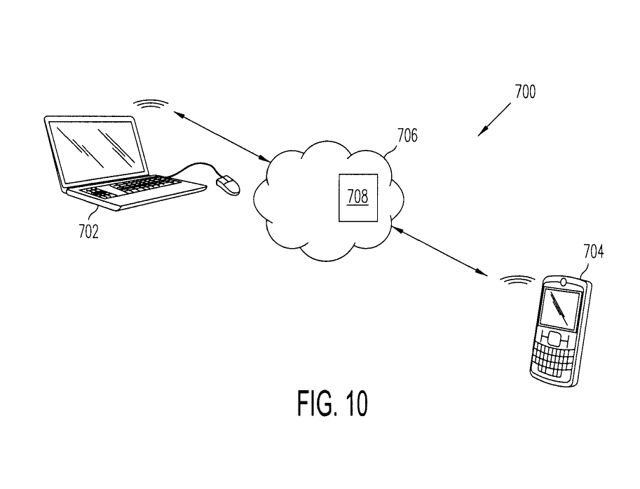

FIG. 10 illustrates an example cloud-based computing architecture 700, which may also be used to implement various aspects of the present disclosure. The cloud-based computing architecture 700 includes a mobile device 704 and a computer 702, both connected to a computer network 706 (e.g., the Internet or an intranet). In one example, a consumer has the mobile device 704, which is configured to run software to provide an app with functionalities described above with reference to FIGS. 1-7.

The mobile device 704 is in communication with cloud-based resources 708, which may include one or more computers, such as server computers, with adequate memory resources to handle requests from a variety of users. A given embodiment may divide up the functionality between the mobile device 704 and the cloud-based resources 708 in any appropriate manner. For example, an app on mobile device 704 may perform basic input/output interactions with the user, but a majority of the processing and caching may be performed by the cloud-based resources 708. However, other divisions of responsibility are also possible in various embodiments.

The cloud-based computing architecture 700 also includes the personal computer 702 in communication with the cloud-based resources 708. In one example, a participating merchant or consumer/user may access information from the cloud-based resources 708 by logging on to a merchant account or a user account at computer 702.

It is understood that the various components of cloud-based computing architecture 700 are shown as examples only. For instance, a given user may access the cloud-based resources 708 by a number of devices, not all of the devices being mobile devices. Similarly, a merchant or another user may access resources 708 from any number of suitable mobile or non-mobile devices. Furthermore, the cloud-based resources 708 may accommodate many merchants and users in various embodiments.

FIG. 11 is a simplified block diagram of an electronic system 800 for managing a digital wallet. For example, the electronic system 800 may be used by a digital wallet provider to carry out the steps for adding user-specified items to a user's digital wallet and displaying the digital wallet. In some embodiments, the electronic system 800 may include one or more computer servers operable to perform the method 500 of FIG. 8.

The electronic system 800 includes an input/output interface module 810. The interface module 810 is operable to receive an input from an external entity and communicate an output to the external entity. The external entity may include a merchant or a consumer. In an embodiment, the input/output interface module 810 includes a visual display unit. The input/output interface module 810 may also include physical and/or virtual buttons, keyboards, mouse, track balls, speakers, microphones, light-sensors, light-emitting diodes (LEDs), communications ports (such as USB or HDMI ports), joy-sticks, image-capture devices (for example cameras), etc.

The electronic system 800 includes a transceiver module 820. The transceiver module 820 contains various electronic circuitry components configured to conduct telecommunications with one or more external devices. The electronic circuitry components allow the transceiver module 820 to conduct telecommunications in one or more of the wired or wireless telecommunications protocols, including communications protocols such as IEEE 802.11 (WiFi), IEEE 802.15 (Bluetooth), GSM, CDMA, LTE, WIMAX, DLNA, HDMI, etc. In some embodiments, the transceiver module 820 includes antennas, filters, low-noise amplifiers, digital-to-analog (DAC) converters, analog-to-digital (ADC) converters, and transceivers. The transceiver module 820 may further include circuitry components such as mixers, amplifiers, oscillators, phase-locked loops (PLLs), and/or filters. Some of these electronic circuitry components may be integrated into a single discrete device or an integrated circuit (IC) chip.

The electronic system 800 also includes a computer processor module 830 that is operable to execute computer instructions. The computer processor module 830 may contain one or more central processing units (CPUs), graphics processing units (GPUs), or digital signal processors (DSPs), which may each be implemented using various digital circuit blocks (including logic gates such as AND, OR, NAND, NOR, XOR gates, etc) along with certain software code.

The electronic system 800 includes a memory storage module 840. The memory storage module 840 may contain various forms of digital memory, such as hard disks, FLASH, SRAM, DRAM, ROM, EPROM, memory chips or cartridges, etc. Computer programming code may be permanently or temporarily stored in the memory storage module 840, for example. The processor module 830 may be used to execute the computer programming code stored in the memory storage module 840.

In some embodiments, the electronic system 800 may also be implemented on a portable electronic device such as a mobile telephone or a computer tablet.

It should be appreciated that like reference numerals are used to identify like elements illustrated in one or more of the figures, wherein these labeled figures are for purposes of illustrating embodiments of the present disclosure and not for purposes of limiting the same.

One aspect of the present disclosure involves a system. The system includes: a computer memory storage module configured to store executable computer programming code; and a computer processor module operatively coupled to the computer memory storage module, wherein the computer processor module is configured to execute the computer programming code to perform the following operations: receiving a request to add an item to a digital wallet of a user, wherein the request is triggered by an activation of a digital wallet triggering element on a service provider site; determining the item from the request; identifying an account of the user; and storing the item in the digital wallet of the user.

Another aspect of the present disclosure involves an apparatus comprising a non-transitory, tangible machine-readable storage medium storing a computer program, wherein the computer program contains machine-readable instructions that when executed electronically by processors, perform: receiving a request to add an item to a digital wallet of a user, wherein the request is triggered by an activation of a digital wallet triggering element on a service provider site; determining the item from the request; identifying an account of the user; and storing the item in the digital wallet of the user.

Yet another aspect of the present disclosure involves a method of conducting an electronic transaction. The method includes: receiving a request to add an item to a digital wallet of a user, wherein the request is triggered by an activation of a digital wallet triggering element on a service provider site; determining the item from the request; identifying an account of the user; and storing the item in the digital wallet of the user. The receiving, the determining, the identifying, and the storing are performed by one or more electronic processors.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system, comprising:
a computer memory storage module configured to store executable computer programming code; and
a computer processor module operatively coupled to the computer memory storage module, wherein the computer processor module is configured to execute the computer programming code to perform the following operations:
receiving a request to add an item to a digital wallet of a user, wherein the request is triggered by an activation of a digital wallet triggering element on a service provider site;
determining the item from the request;
identifying an account of the user; and
storing the item in the digital wallet of the user.

2. The system of claim 1, further comprising:
receiving, from the service provider, a request to set up the digital wallet triggering element;
generating a unique key in response to the request; and
sending the key to the service provider to facilitate the setup of the digital wallet triggering element by the service provider.

3. The system of claim 1, further comprising: a communications module configured to conduct electronic communications with external entities including the service provider and the user.

4. The system of claim 1, wherein the computer processor module is configured to execute the computer programming code to further perform: displaying the digital wallet in response to a request from the user.

5. The system of claim 4, wherein the digital wallet triggering element specifies additional content or actions that are associated with the item from the request.

6. The system of claim 5, wherein the content is retrievable by a user interaction with the item.

7. The system of claim 1, wherein the computer processor module is configured to execute the computer programming code to further perform: authenticating the user before the storing the item to the digital wallet of the user.

8. The system of claim 1, wherein the computer processor module is configured to execute the computer programming code to further perform: analyzing the item to detect fraud or obscene or copyrighted material before the storing the item to the digital wallet of the user.

9. The system of claim 1, wherein the digital wallet triggering element comprises a virtual button on a webpage of the service provider.

10. An apparatus comprising a non-transitory, tangible machine-readable storage medium storing a computer program, wherein the computer program contains machine-readable instructions that when executed electronically by one or more computer processors, perform:
receiving a request to add an item to a digital wallet of a user, wherein the request is triggered by an activation of a digital wallet triggering element on a service provider site;
determining the item from the request;
identifying an account of the user; and
storing the item in the digital wallet of the user.

11. The apparatus of claim 10, wherein the instructions further comprise instructions for:
receiving, from the service provider, a request to set up the digital wallet triggering element;
generating a unique key in response to the request; and
sending the key to the service provider to facilitate the setup of the digital wallet triggering element by the service provider.

12. The apparatus of claim 10, wherein the instructions further comprise: instructions for displaying the digital wallet in response to a request from the user.

13. The apparatus of claim 12, wherein the digital wallet triggering element specifies additional content or actions that are associated with the item from the request.

14. The apparatus of claim 13, wherein the content is retrievable by a user interaction with the item.

15. The apparatus of claim 10, wherein the instructions further comprise: instructions for authenticating the user before the storing the item to the digital wallet of the user.

16. The apparatus of claim 10, wherein the instructions further comprise: instructions for analyzing the item to detect fraud or obscene or copyrighted material before the storing the item to the digital wallet of the user.

17. The apparatus of claim 10, wherein the digital wallet triggering element comprises a virtual button on a webpage of the service provider.

18. A method, comprising:
receiving a request to add an item to a digital wallet of a user, wherein the request is triggered by an activation of a digital wallet triggering element on a service provider site;
determining the item from the request;
identifying an account of the user; and
storing the item in the digital wallet of the user;
wherein the receiving, the determining, the identifying, and the storing are performed by one or more electronic processors.

19. The method of claim 18, further comprising:
receiving, from the service provider, a request to set up the digital wallet triggering element;
generating a unique key in response to the request; and
sending the key to the service provider to facilitate the setup of the digital wallet triggering element by the service provider.

20. The method of claim 18, further comprising: displaying the digital wallet in response to a request from the user.

21. The method of claim 20, wherein the digital wallet triggering element specifies additional content or actions that are associated with the item from the request, and wherein the content is retrievable by a user interaction with the item.

22. The method of claim 18, further comprising: authenticating the user before the storing the item to the digital wallet of the user.

23. The method of claim 18, further comprising: analyzing the item to detect fraud or obscene or copyrighted material before the storing the item to the digital wallet of the user.

24. The method of claim 18, wherein the receiving, the sending, the storing, and the displaying are performed electronically by the one or more processors of the digital wallet provider, and wherein the service provider is unaffiliated with the digital wallet provider.

25. The method of claim 18, wherein the digital wallet triggering element comprises a virtual button on a webpage of the service provider.
